(19) United States
(12) Patent Application Publication
(10) Pub. No.: US 2019/0364891 A1
(43) Pub. Date: Dec. 5, 2019

(54) Chemical Compositions for Combating Honey Bee Pests and Pathogens

(71) Applicant: Fort Lewis College, Durango, CO (US)

(72) Inventor: William R. Collins, Durango, CO (US)

(21) Appl. No.: 16/414,927

(22) Filed: May 17, 2019

Related U.S. Application Data
(60) Provisional application No. 62/673,889, filed on May 19, 2018.

(51) Int. Cl. A01N 37/10; A01K 51/00; A01N 25/00

(52) U.S. Cl. CPC A01N 37/10; A01N 25/002; A01K 51/00

(57) ABSTRACT

Compositions and methods that reduce Varroa mite populations within a honey bee colony are disclosed. The compositions and methods utilize relatively high concentrations of one or more naturally occurring molecules that are found within honey and/or propolis within a honey bee colony at low concentrations.

### CROSS-REFERENCE TO RELATED APPLICATIONS

This application claims the benefit of and priority to U.S. Provisional Patent Application No. 62/673,889, filed May 19, 2018, which is hereby incorporated by reference in its entirety.

### GOVERNMENT RIGHTS

None.

### BACKGROUND

Worldwide honey bee (Apis milifera) populations are in a state of instability, with beekeepers experiencing high colony losses due to a variety of pests and pathogens. In particular, Varroa destructor (an ectoparasitic mite) weakens honey bees' immune systems and vectors honey bee viruses. These factors along with bacterial infections, fungal infections, and other viruses have been implicated in honey bee colony losses.

There are very few products available to beekeepers to manage mites and many of the available products have lost considerable efficacy due to the emergence of miticide-resistance. Moreover, few, if any, new products reaching the market can demonstrate toxicity to mites while simultaneously safeguarding honey bees and maintaining the salability of the honey harvest for human consumption.

Exam plary studies and reports of honey bee pests, parasites, and mitigation agents include: Popova et al. “Propolis chemical composition and honeybee resistance against Varroa destructor”, Natural Product Research (2014), European Patent Application No. EP2949220, Mao et al. “Honey constituents up-regulate detoxification and immunity genes in the western honey bee Apis mellifera” Proc. Natl. Acad. Sci. v. 110, no. 22, 28 May 2013, pp. 8842-8846, Bilikova et al. “New anti-Paenibacillus larvae substances purified from propolis” Apidologie (2013) 44:278-285, US Patent Pub. No. US 2017/035820, and Simone-Finstrom et al. “Propolis Counteracts Some Threats to Honey Bee Health” Insects, 2017, 8, 46.

### SUMMARY

Compositions and methods that reduce Varroa mite populations within a honey bee colony are disclosed. The compositions and methods utilize relatively high concentrations of one or more naturally occurring molecules that are found within honey and/or propolis within a honey bee colony at low concentrations. Even at the relatively high concentrations present in the disclosed compositions, these natural, plant-based molecules are non-toxic to honey bees and do not negatively contaminate honey for human consumption.

In an aspect, a composition comprises an isolated propolis chemical (IPC) or a derivative thereof in a concentration greater than or equal to 25 mg/mL and an excipient.

In an embodiment, an IPC is selected from the group consisting of caffeic acid, caffeates, ferulic acid, ferulates and combinations thereof. In an embodiment, the caffeate is selected from the group consisting of caffeic acid cinnamyl ester, caffeic acid phenethyl ester (CAPE), caffeic acid 3-methyl-3-butenyl ester, caffeic acid 3-methyl-2-butenyl ester, caffeic acid benzyl ester, caffeic acid alkyl esters and combinations thereof. In an embodiment, the ferulate is selected from the group consisting of ferulic acid cinnamyl ester, ferulic acid phenethyl ester, ferulic acid 3-methyl-3-butenyl ester, ferulic acid 3-methyl-2-butenyl ester, ferulic acid benzyl ester, ferulic acid alkyl esters and combinations thereof. For example, the alkyl group of a caffeic acid alkyl ester or ferulic acid alkyl ester may be methyl, ethyl, n-propyl, isopropyl, n-butyl, t-butyl, n-pentyl or branched pentyl.

In an embodiment, the IPC is present in a concentration between 25 mg/mL and 1000 mg/mL, or between 30 mg/mL and 750 mg/mL, or between 35 mg/mL and 500 mg/mL, or between 40 mg/mL and 350 mg/mL, or between 50 mg/mL and 250 mg/mL, or between 75 mg/mL and 200 mg/mL.

In an embodiment, an excipient is selected from the group consisting of water, methanol, ethanol, n-propanol, isopropyl alcohol, n-butanol, t-butyl alcohol, methylene chloride, dimethylsulfoxide, dichloromethane and combinations thereof.

In an embodiment, a composition disclosed herein further comprises at least one additive selected from the group consisting of a bee feeding supplement, a preservative, a colorant, an additional IPC or derivative thereof, a miticide and combinations thereof.

In an embodiment, the bee feeding supplement is selected from the group consisting of glucose, fructose, sucrose, honey, a protein patty supplement, and combinations thereof.

In an embodiment, the additional IPC or derivative thereof is selected from the group consisting of hydroxycinnamic acid, cinnamic acid, coumaric acid, cichoric acid, coumarin, sinapinic acid and combinations thereof. In an embodiment, the concentration of the additional IPC or derivative thereof is between 25 mg and 1000 mg, or between 30 mg and 750 mg, or between 35 mg and 500 mg, or between 40 mg and 350 mg, or between 50 mg and 250 mg, or between 50 mg and 150 mg.

In an embodiment, the miticide, which may be a synthetic or natural miticide, is selected from the group consisting of oxalic acid, formic acid, fluvalinate, thymol, and combinations thereof. In an embodiment, the concentration of the miticide is between 1 g and 3 g for oxalic acid, 0.01 g/L to 0.16 g/L for formic acid, 1 g and 50 g for thymol, and 500 mg to 2 g fluvalinate.

In an embodiment, a composition disclosed herein is a liquid, a solid, a gas or a gel.

In an embodiment, a composition disclosed herein is a miticide. In an embodiment, the miticide achieves at least 50% mortality within 24 hours, or 12 hours, or 6 hours after contact exposure for at least 45 minutes, or 30 minutes, or 15 minutes.

In an embodiment, a substrate is impregnated or coated with a composition disclosed herein. In an embodiment, the substrate is paper, wood, a beehive, a portion of a beehive or plastic. In an embodiment, the substrate comprises 0.5 mg to 25 mg, or 0.7 to 20 mg, or 1 mg to 15 mg, or 1.5 mg to 10 mg of IPC or derivative thereof per square centimeter.

In an aspect, a method for treating a beehive to combat Varroa mites comprises administering a composition disclosed herein to at least a portion of a beehive.

In an embodiment, a step of administering comprises spraying, dipping or fumigating a beehive or a portion of a beehive with the composition, introducing a substrate impregnated or coated with a composition disclosed herein onto or into a beehive, coating at least a portion of a bee with the composition, feeding the composition to a bee and combinations thereof.

In an embodiment, a dosage of 25 mg to 2000 mg, or 30 mg to 1500 mg, or 35 mg to 1250 mg, or 40 mg to 1000 mg, or 45 mg to 750 mg, or 50 mg to 500 mg, or 25 mg to 1000 mg, or 25 mg to 750 mg, or 25 mg to 500 mg is administered for treating or preventing mite infestations.

In an embodiment, a composition disclosed herein is administered once a day, once a week, once a month, once every 2 months, once every 6 months or once a year.

In an aspect, a substrate is impregnated or coated with a composition comprising an isolated propolis chemical (IPC) or a derivative thereof, wherein the substrate comprises 0.5 mg to 25 mg of the IPC or derivative thereof per square centimeter.

### BRIEF DESCRIPTION OF THE DRAWINGS

Illustrative embodiments of the present invention are described in detail below with reference to the attached drawings, wherein:

FIG. 1 is a schematic illustrating exemplary isolated propolis compound derivatives; and

FIG. 2 shows exemplary chemical reactions for synthesizing the isolated propolis compounds disclosed herein.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

“Propolis” refers to a resinous substance that honey bees produce by mixing saliva and beeswax with exudate gathered from botanical sources. Propolis is used to seal open spaces in the hive.

As used herein, a “synthetic miticide” is a man-made molecule that induces mortality in mites and is not found in nature.

As used herein, a “natural miticide” is a molecule that induces mortality in mites and is found in nature. A natural miticide may be man-made or isolated from a natural source, such as organic matter.

As used herein, an “excipient” is an inactive substance that serves as the vehicle or medium for an active substance, such as an isolated propolis compound.

The term “alkyl” refers to a saturated linear or branched-chain monovalent hydrocarbon radical of one to sixteen carbon atoms, wherein the alkyl radical may be optionally substituted independently with one or more substituents.

The term “alkenyl” refers to a linear or branched-chain monovalent hydrocarbon radical of two to sixteen carbon atoms with at least one site of unsaturation, i.e., a carbon-carbon, sp² double bond, wherein the alkenyl radical may be optionally substituted independently with one or more substituents, and includes radicals having “cis” and “trans” orientations, or alternatively, “E” and “Z” orientations.

The term “alkynyl” refers to a linear or branched monovalent hydrocarbon radical of two to sixteen carbon atoms with at least one site of unsaturation, i.e., a carbon-carbon, sp triple bond, wherein the alkynyl radical may be optionally substituted independently with one or more substituents.

The terms “aryl” or “aromatic” as used herein refer to a substituted or unsubstituted carbocyclic aromatic group having about 6 to 12 carbon atoms.

“Substituted” means that at least one hydrogen atom bound to a carbon atom is replaced with one or more substituents that are functional groups such as alkyl, alkenyl, alkynyl, aryl, heteroaryl, hydroxyl, alkoxyl, thio, amino, halo, cyano and the like.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

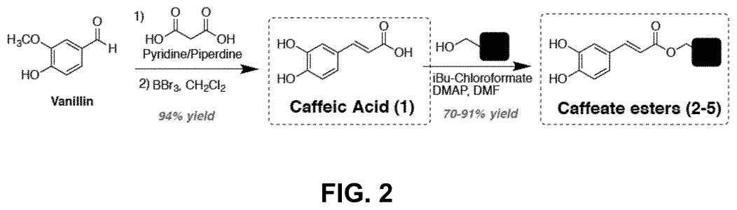

Compounds suitable for use in the present compositions may be commercially obtained, synthesized or isolated from natural sources. In an embodiment, shown in FIG. 2, synthesis begins from commercially available and inexpensive vanillin and malonic acid. After the condensation reaction and methyl deprotection by boron tribromide, the desired parent caffeic acid (1) can be isolated in excellent yield. The corresponding ferulic acid can be generated from this route by foregoing the methyl deprotection. The caffeic acid can then undergo esterification to provide the caffeate esters (2-5), and the ferulic acid can undergo esterification to provide ferulic esters, in good to moderate yields.

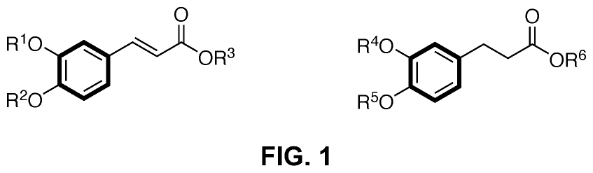

FIG. 1 is a schematic illustrating exemplary isolated propolis compound derivatives. In an embodiment, R¹-R⁶ are independently selected from the group consisting of hydrogen, linear or branched alkyl, alkenyl, alkynyl or aryl group that is optionally substituted. In an embodiment, R¹-R⁶ are independently selected from the group consisting of hydrogen, methyl, ethyl, n-propyl, isopropyl, n-butyl, t-butyl, n-pentyl, branched pentyl, phenethyl, benzyl, 3-methyl-3-butenyl, 3-methyl-2-butenyl, and cinnamyl.

For the treatment of Varroa mites, molecules are dissolved in ethanol in various concentrations and evenly deposited onto a filter paper substrate. After allowing the ethanol to fully evaporate, the substrate can be utilized to induce contact toxicity with Varroa mites.

The use of compositions and methods disclosed herein is further illustrated by the following Examples. These Examples are for illustrative purposes only and are not intended to limit the invention.

### Example 1

Efficacy of 12 caffeic and ferulic acid/ester molecules (caffeic acid, ferulic acid, caffeic acid cinnamyl ester, caffeic acid phenethyl ester, caffeic acid 3-methyl-3-butenyl ester, caffeic acid 3-methyl-2-butenyl ester, caffeic acid benzyl ester, ferulic acid cinnamyl ester, ferulic acid phenethyl ester, ferulic acid 3-methyl-3-butenyl ester, ferulic acid 3-methyl-2-butenyl ester, ferulic acid benzyl ester) against Varroa mites in a laboratory assay was determined. Adult female mites were collected from a single honey bee colony by uncapping drone cells and removing the mites to avoid injury that might occur if other methods (e.g., sugar shake) were used. Mites lacking vigor were discarded prior to experiment. Varroa were removed from single-age pupae, randomized, and placed in groups of ten in a sealed chamber. They were left in an incubator with pupae. After a set amount of time, the Varroa were transferred to a chamber with a potential miticide. The effects of each miticide were evaluated both through contact and through vapor. Concentrations and contact time were also evaluated. The Varroa were then transferred back to their chamber in the incubator and checked for mortality (each experiment in triplicate). The following treatments were assayed: No treatment control, thymol (100 mg/mL as positive control—yielding 100% mortality at 6 h), ethanol control (ethanol is used as a solvent for dissolving the caffeic and ferulic acid/ester components), 100 mg/mL, 250 mg/mL, 1 g/mL of caffeic and ferulic acid/ester molecules. Treatments were tested for their efficacy in repelling and killing mites.

To test for repellency, a 4×7 cm rectangle of Whatman No. 4 filter paper sectioned with a pencil into three zones (two 1×4 cm zones at the far ends and a central 4×5 cm zone) was used. 250 μl of test solution was applied evenly on both sides of the central zone of the filter paper. After allowing 10-15 min for the test solution to dry, the filter paper was placed in the center of a 120 mm Petri dish. Ten mites per dish were placed directly in the center of the filter paper. Locations of the mites were recorded at 1, 3, 5, 10, and 15 min. Mites were considered repelled if they were in the untreated zone at 15 min. Each treatment was repeated three times.

Results of Vapor-Phase Studies

To test for vapor-phase miticidal activity, 250 μl of each treatment was evenly applied to a Whatman No. 4 filter paper in a Petri dish. The paper was allowed to completely dry before the assay and then it was adhered to the inner cover of the dish. Ten mites per treatment were placed directly on the bottom of the dish and the mites were kept in the dish for either 15 min, 30 min, or 45 min. After the initial time period, all mites were transferred into a sterile Petri dish and maintained in an incubator for 30 h. Each hour the mites were removed and observed under a dissecting lens. Each treatment concentration and exposure period was repeated three times. There was no statistically significant increase in mortality at 30 h.

Results of Contact Toxicity Studies

To test for contact-phase miticidal activity, 250 μl of each treatment was evenly applied to a Whatman No. 4 filter paper in a Petri dish. The paper was allowed to completely dry before the assay and then it was adhered to the bottom of the dish. Ten mites per treatment were placed directly on the filter paper and the mites were kept in the dish for either 15 min, 30 min, or 45 min. After the initial time period, all mites were transferred into a sterile Petri dish and maintained in an incubator for 30 h. Each hour the mites were removed and observed under a dissecting lens. Each treatment concentration and exposure period was repeated three times.

Statistical analysis for repellency was conducted on the mean number of mites repelled and was compared by a two-way ANOVA. It was found that the mites were not repelled by the treatment. Percent mortality was compared between treatments by a non-parametric Kruskal-Wallis test. It was found that all of the molecules except caffeic acid and ferulic acid showed statistically significant mite mortality at 24 h. Three of the 10 molecules (ferulic acid 3-methyl-2-butenyl ester, caffeic acid phenethyl ester, and caffeic acid cinnamyl ester) yielded over 60% mortality at 24 h. One of the 10 molecules (caffeic acid phenethyl ester) provided 100% mortality at 24 h.

### Example 2

In a series of assays, Whatman filter paper was impregnated with various concentrations of the caffeic ester family of molecules. Varroa mites were freshly harvested from brood frames and then directly exposed to the substrate. The exposure time was varied across different experiments. The Varroa mites were removed and placed into an incubator with pupae to feed on. Mite mortality and mite activity was assessed at several time points (6 h, 24 h, 30 h) post exposure. Caffeic acid phenethyl ester was the most efficacious molecule tested.

### Example 3

Field trials will use honey bee colonies housed in single-deep Langstroth hives infested with Varroa mites at ˜2% infestation as estimated by the alcohol wash method. If needed, the level of infestation will be equalized between the hives. One week prior to the beginning of the treatments, all the test hives will be requeened with sister queens. Concentrations of the caffeic acid/ester product to be applied will be determined based on the conducted laboratory assays. Treatments will be untreated control, positive control (thymol), low dose of caffeic acid/ester and high dose of caffeic acid/ester. Treatment will be applied to Whatman No. 4 filter papers and these papers will be positioned above the brood nest.

Each treatment will consist of 8-10 replicate colonies, which will be arranged in randomized complete block design but in such a way to minimize the drift between the colonies. If more than one apiary needs to be used, the treatments will be split equally between the apiaries and the apiary site will be used as a variable in the final statistical analysis.

The level of Varroa mite infestation will be determined with an alcohol wash prior to the treatment, twice during the treatment, and once at the end of the treatment (for a total of 4 counts per treatment application). Varroa mite counts will also be determined via “sealed brood counts” before and after the treatment. Effects on colony strength will be measured by counting the number of frames of adult bees, brood, honey and pollen before and after the treatment.

Statistical analyses for mite counts and honey bee colony strength will be completed with Repeated Measures ANOVA to determine significant differences between treatments over times. Mite counts will also be analyzed before and after treatments with a non-parametric Kruskal-Wallis test.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a molecule” includes a plurality of such molecules and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim elements. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

What is claimed is:

1. A composition comprising:
an isolated propolis chemical (IPC) or a derivative thereof in a concentration greater than or equal to 25 mg/mL; and
an excipient.

2. The composition of claim 1, wherein the IPC is selected from the group consisting of caffeic acid, caffeates, ferulic acid, ferulates and combinations thereof.

3. The composition of claim 2, wherein the caffeate is selected from the group consisting of caffeic acid cinnamyl ester, caffeic acid phenethyl ester (CAPE), caffeic acid 3-methyl-3-butenyl ester, caffeic acid 3-methyl-2-butenyl ester, caffeic acid benzyl ester, caffeic acid alkyl esters and combinations thereof.

4. The composition of claim 2, wherein the ferulate is selected from the group consisting of ferulic acid cinnamyl ester, ferulic acid phenethyl ester, ferulic acid 3-methyl-3-butenyl ester, ferulic acid 3-methyl-2-butenyl ester, ferulic acid benzyl ester, ferulic acid alkyl esters and combinations thereof.

5. The composition of claim 1, wherein the IPC is present in a concentration between 25 mg/mL and 1000 mg/mL.

6. The composition of claim 1, wherein the excipient is selected from the group consisting of water, methanol, ethanol, n-propanol, isopropyl alcohol, n-butanol, t-butyl alcohol, methylene chloride, dimethylsulfoxide, dichloromethane and combinations thereof.

7. The composition of claim 1 further comprising at least one additive selected from the group consisting of a bee feeding supplement, a preservative, a colorant, an additional IPC or derivative thereof, a synthetic miticide, a natural miticide and combinations thereof.

8. The composition of claim 7, wherein the bee feeding supplement is selected from the group consisting of glucose, fructose, sucrose, honey, a protein patty supplement, and combinations thereof.

9. The composition of claim 7, wherein the additional IPC or derivative thereof is selected from the group consisting of hydroxycinnamic acid, cinnamic acid, coumaric acid, cichoric acid, coumarin, sinapinic acid and combinations thereof.

10. The composition of claim 7, wherein the synthetic or natural miticide is selected from the group consisting of oxalic acid, formic acid, fluvalinate, thymol, and combinations thereof.

11. The composition of claim 10, wherein the concentration of the synthetic or natural miticide is between 1 g and 3 g for oxalic acid, 0.01 g/L to 0.16 g/L for formic acid, 1 g and 50 g for thymol, and 500 mg to 2 g for fluvalinate.

12. The composition of claim 1, wherein the composition is a liquid, a solid, a gas or a gel.

13. The composition of claim 1, wherein the composition is a miticide that achieves at least 50% mortality within 24 hours after contact exposure for at least 45 minutes.

14. A method for treating a beehive to combat Varroa mites, the method comprising administering the composition of claim 1 to at least a portion of a beehive.

15. The method of claim 14, wherein the step of administering comprises spraying, dipping or fumigating a beehive or a portion of a beehive with the composition, introducing a substrate impregnated or coated with the composition onto or into a beehive, coating at least a portion of a bee with the composition, feeding the composition to a bee and combinations thereof.

16. The method of claim 14, wherein a dosage of 25 mg to 2000 mg is administered for treating or preventing mite infestations.

17. A substrate impregnated or coated with a composition:
the composition comprising an isolated propolis chemical (IPC) or a derivative thereof;
wherein the substrate comprises 0.5 mg to 25 mg of the IPC or derivative thereof per square centimeter.

18. The substrate of claim 17, wherein the substrate is paper, wood, a beehive, a portion of a beehive or plastic.

19. The substrate of claim 17, wherein the IPC is selected from the group consisting of caffeic acid, caffeates, ferulic acid, ferulates and combinations thereof.

20. The substrate of claim 17, wherein the composition further comprises at least one additive selected from the group consisting of a bee feeding supplement, a preservative, a colorant, an additional IPC or derivative thereof, a synthetic miticide, a natural miticide and combinations thereof.
